(19) United States
(12) Patent Application Publication
(10) Pub. No.: US 2004/0233348 A1
(43) Pub. Date: Nov. 25, 2004

(54) Light structure for panel display

(75) Inventor: Che-Kuei Mai, Taipei (TW)

Correspondence Address: BACON & THOMAS, PLLC, 625 SLATERS LANE, FOURTH FLOOR, ALEXANDRIA, VA, 22314

(73) Assignee: Toppoly Optoelectronics Corp., Miao-Li (TW)

(21) Appl. No.: 10/691,646

(22) Filed: Oct. 24, 2003

(30) Foreign Application Priority Data
May 21, 2003 (TW) 092113779

(51) Int. Cl. G02F 1/1335

(52) U.S. Cl. 349/69

(57) ABSTRACT

A light structure for panel display is disclosed. The light structure of a panel display includes a back light module having a light source for generating a first color light; and a polarizer having at least one fluorescence layer to be excited by the first color light so as to generate a white light or a mixing light in a second color.

### FIELD OF THE INVENTION

The present invention is related to a light structure, and more particularly to a light structure for a panel display.

### BACKGROUND OF THE INVENTION

With the rapid developments of digital technologies, panel displays have become essential components for many electrical appliances such as notebooks, mobile phones, information appliances (IA) and personal digital assistants (PDAs). Generally speaking, lightness, thinness and/or low electricity consumption are basic requirements of typical panel displays. However, limited by viewing angles, brightness, high image quality and so on, related arts are further developed to improve the technique of panel displays. The liquid crystal display has been developed as a new technology for the panel displays due to its outstanding properties of well brightness, clear picture, wider viewing angle, rapid response, simple manufacturing process and low power consumption. Hence, the liquid crystal display has become the popular product, which is positively researched and improved by the manufacturer recently.

Please refer to FIG. 1, which shows a structure of a conventional transmission-type liquid crystal display. As shown in FIG. 1, due to the liquid crystal molecules cannot emit lights itself, a back light module 10 is required to be disposed on the backside of the panel display to provide lights. The back light module 10 usually has a light source 101, for example at least one fluorescent tube or one light emitting diode (LED), disposed internally or on the two sides of the back light module. The white light 11 emitted from the light source 101 through the reaction of the light guide plate, the reflection plate and the diffusion plate of the back light module 10 are emitted uniformly from the surface of the back light module 10 to pass through a bottom polarizer 12, a glass substrate 13, a liquid crystal layer 14, a color filter 15 and a top polarizer 16 so as to form images in people's eyes. In other words, the liquid crystal display utilizes the white light 11 emitted from the back light module 10 to be transmitted sequentially through the bottom polarizer 12, the glass substrate 13 and the liquid crystal layer 14. Meanwhile, the arrangement of the liquid crystal molecules in the liquid crystal display can be altered by means of adjusting the voltage between the indium tin oxide (ITO) films 17 so as to deflect the incident light to have a specific angle. After that, the incident light further needs to be transmitted through the color filter 15 and the top polarizer 16. Because the polarized lights from the top polarizer 16 and the bottom polarizer 12 have an angle of 90°, the incident light will be originally blocked and intercepted. However, since the liquid crystal layer 14 can deflect the incident light by means of adjusting the voltage between indium tin oxide (ITO) films 17, the intensity and the color of the emitting light 18 can be controlled by adjusting the voltage between the indium tin oxide (ITO) films 17. Thereby, different color combinations of the light can be shown on the liquid crystal display.

The back light module 10 and the polarizers 12, 16 are important optical devices with respect to the LCD. The background technologies of these devices are described as follows:

Please refer to FIG. 2, which illustrates a structure of a conventional polarizer. As shown in FIG. 2, the conventional polarizer consists of a surface protective layer 21, a first protective layer 22, a polarizing layer 23, a second protective layer 24, an adhesive layer 25 and a release film 26. The polarizing layer 23 is made of polyvinyl alcohol (PVA), which has a feature of polarizing light so as to be served as the polarization substrate. After the PVA is extended, the mechanical properties of the PVA are reduced so that the polarizing layer will be fragile. Therefore, when the PVA is extended to form as a film, two sides of the PVA will be coated with protective layers 22, 24, such as the triacetyl-cellulose (TAC), for protecting the PVA film and preventing the PVA film from shrinking. Furthermore, the surface protective layer 21 and the release film 26 can be added on the first protective layer 22 and the second protective layer 24 for protecting the polarizers in storage and transportation.

Generally, the ordinary light source is multi-directional and not polarized, and the polarizer of the LCD serves as a light-filter to filter out the light in all directions other than the light in a specific direction (i.e. transforming the non-polarized light into the polarized light). The LCD generally includes a top polarizer and a bottom polarizer, wherein the polarized lights of two polarizers have an angle of 90°. Therefore, the light passing through one of the polarizers will not be able to pass through the other polarizer. If the liquid crystal molecules of the liquid crystal layer are disposed and twisted between two polarizers for guiding the polarized light to be deflected 90°, the polarized light will be then able to transmit through the other polarizer. But if the liquid crystal layer is deflected to the same direction with the polarized light from the first polarizer by altering the voltage, the polarized light will not be able to pass through the second polarizer. Accordingly, the brightness of the light on the panel display can be adjusted by means of altering the voltage to control the twisting angle of the liquid crystal molecules.

With regard to the components of the back light module 10, the back light module 10 consists of a light source, a light guide plate, a reflection plate, a diffusion sheet and a brightness enhancement sheet. Conventionally, the light source of the back light module 10 may be a fluorescent tube or light emitting diodes (LEDs), however, because of the development tendency focusing on Slimmer and lighter LCDs, a slimmer and lighter back light module 10 has become a key part of recent research. Therefore, the light source of the back light module 10 is replaced with LED because of its features of high brightness, long lifetime, good reliability and low cost. LEDs have developed recently to have several colors: red, orange, yellow, green yellow, green, blue and white color. Hence, the LED has been regarded as a preferable choice of the light source of the back light module and has become an important ingredient in manufacturing back light modules of panel displays.

Please refer to FIGS. 3(a) and 3(b), which separately illustrates two kinds of back light modules with LEDs as required light sources. As shown in FIGS. 3(a) and 3(b), the LED 31 is disposed on the one side of the light guide plate 32. Through the reaction of the light guide plate 32, the reflection plate 33, the diffusion plate 34 or the brightness enhancement plate 35, the light emitted from the LED 31 is transmitted and emitted uniformly from the surface of the back light module. Usually, the LED emitting white color is employed as a light source in manufacturing TFT-LCD displays with general sizes. In the conventional technology, the method employed in an LED device emitting white color light is to dispose a light-emitting chip on a fillister of an electrode frame and coat at least one layer of fluorescent powder on the surface of the light-emitting chip for mixing the color of the light-emitting chip and the color of the fluorescent powder to have a white color light. For example, a red light-emitting chip coated with blue and green fluorescent powder will result in white color light, and the blue light-emitting chip coated with yellow fluorescent powders will also result in white color light. Therefore, if the emitting efficiency and the lifetime of the LED device are taken into consideration, the LED emitting white color light sold by the NICHIA Company is the only kind of LED element that can be used. However, the lifetime and the cost of the LED emitting white color light are not as good as the LED emitting red color, green color and yellow color, and the lifetime of the panel display will be decreased and the cost of the panel display will be increased if one uses the LED emitting white color light only.

Therefore, it is required to provide a light structure for the panel display, which is capable of being produced easily and efficiently. Further, it is also required to provide a light structure with low manufacturing cost and can rectify those drawbacks of the prior art.

### SUMMARY OF THE INVENTION

It is therefore a primary object of the present invention to provide an improved light structure for a panel display, which can substitute the traditional back light module only providing white light thereby increasing the lifetime of the panel display and decreasing the cost thereof.

It is therefore another object of the present invention to provide a light structure for a panel display, which employs a LED emitting several colors other than white color to be the light source of a back light module and through the influence of the color of fluorescence layers to provide a white light or a mixing light in a second color.

The present invention according to the above objects provides a light structure of a panel display, which at least includes a back light module having a light source for generating a first color light and a polarizer having at least a fluorescence layer to be excited by the first color light so as to generate a white light or a mixing light in a second color.

Accordingly, the polarizer can be a top polarizer or a bottom polarizer of the panel display. Meanwhile, the top polarizer and the bottom polarizer respectively include a polarizing layer and a surface protective layer and the fluorescence layer is disposed between the polarizing layer and the surface protective layer respectively. The polarizer further includes at least one protective layer for protecting the fluorescence layer. In the preferred embodiment, the light source is a light emitting diode (LED) and the panel display is a low temperature poly-silicon (LTPS) thin film transistor liquid crystal display (TFT-LCD).

In one preferred embodiment of the present invention, if the first color light is red, the polarizer may comprise a green fluorescence layer and a blue fluorescence layer so that the green fluorescence layer and the blue fluorescence layer will be excited by the first color light (i.e. red color light) to generate a white light or a mixing light in a second color. In the other embodiment, if the first color light is green, the polarizer may comprise a red fluorescence layer and a blue fluorescence layer so that the red fluorescence layer and the blue fluorescence layer will be excited by the first color light (i.e. green color light) to generate a white light or a mixing light in a second color. In a further embodiment, if the first color light is blue, the polarizer may comprise a yellow fluorescence layer so that the yellow fluorescence layer will be excited by the first color light (i.e. blue color light) to generate a white light or a mixing light in a second color.

The other object of the present invention is to provide a polarizer, which is disposed on a back light module of a panel display. The polarizer is characterized in that the polarizer includes at least one fluorescence layer to be excited by a first color light to generate a white light or a mixing light in a second color.

In an embodiment of the present invention, the polarizer further includes an adhesive layer, a plurality of protective layers, a polarizing layer and a surface protective layer.

The above objects and advantages of the present invention will become more readily apparent to those ordinarily skilled in the art after reviewing the following detailed description and accompanying drawings, in which:

### BRIEF DESCRIPTION OF THE DRAWING

FIG. 1 illustrates a structure of a conventional transmission-type liquid crystal display;

FIG. 2 illustrates a structure of a conventional polarizer;

FIG. 3(a) illustrates a kind of back light modules with LEDs as light sources;

FIG. 3(b) illustrates another kind of back light modules with LEDs as light sources;

FIG. 4 illustrates a first preferred embodiment of a light structure for a panel display according to the present invention;

FIG. 5 illustrates a second preferred embodiment of a light structure for a panel display according to the present invention; and

FIG. 6 illustrates a third preferred embodiment of a light structure for a panel display according to the present invention.

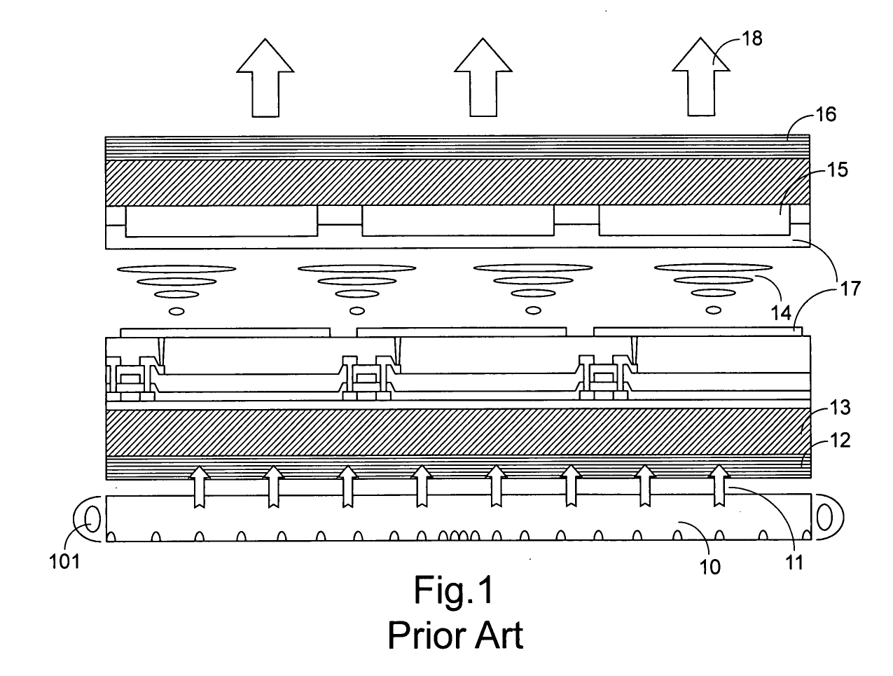

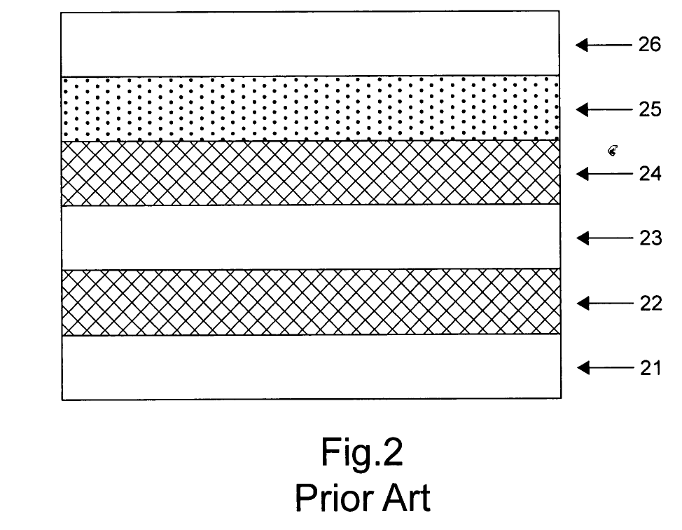

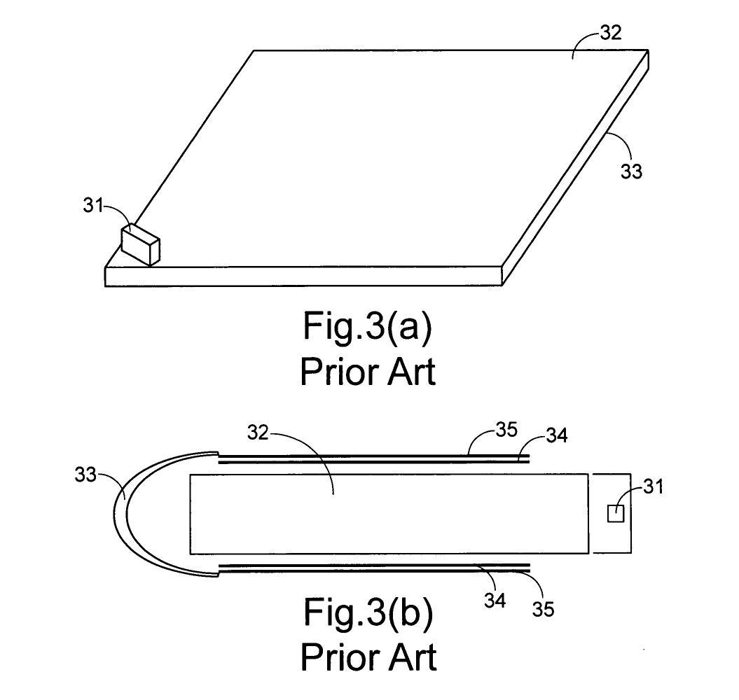

### DETAILED DESCRIPTION OF THE PREFERRED EMBODIMENTS

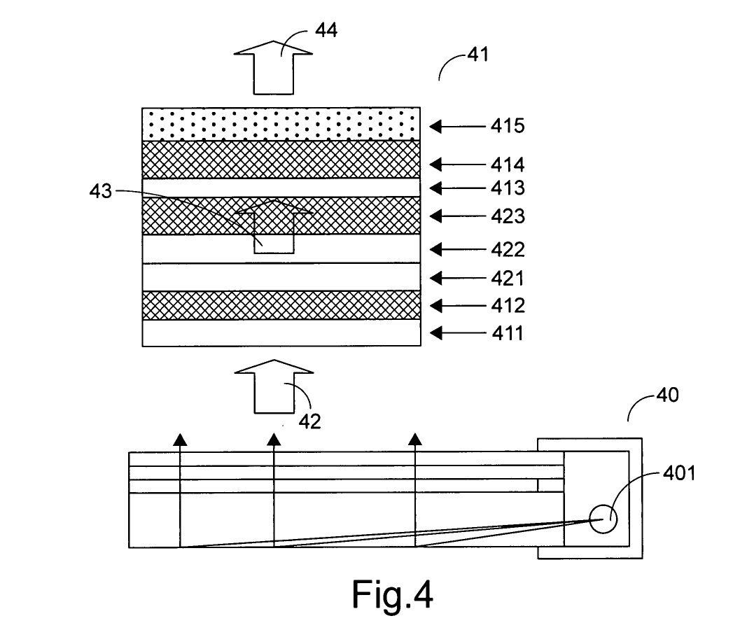

Please refer to FIG. 4, which illustrates a first preferred embodiment of a light structure for a panel display according to the present invention. Being shown in FIG. 4, the light structure of the present invention includes a back light module 40 and a polarizer 41. The back light module 40 employs a non-white LED to be a light source 401. Other elemental devices, for example a light guide plate, a reflection plate, a diffusion sheet, a brightness enhancement sheet, a prism sheet and so on, are the same as those of the prior art and will not be repeatedly described in the following embodiments. Furthermore, the polarizer 41 not only includes one fluorescence layer or several fluorescence layers but also includes a surface protective layer 411, a first protective layer 412, a polarizing layer 413, a second protective 414, an adhesive layer 415 and so on. Those are the same with the prior art and also will not be repeatedly described either.

In the preferred embodiment of the present invention, the back light module 40 introduces an LED 401 emitting red color light as the light source. According to the chromaticity diagram of International Commission on Illumination (CIE) introduced in 1931, the red color light, the green color light and the blue color light could be mixed to form a white color light for the panel display. Other than the surface protective layer 411, the first protective layer 412, the polarizing layer 413, the second protective 414 and the adhesive layer 415, the polarizer 41 also includes a green fluorescence layer 421 and a blue fluorescence layer 422 as light-mixing elements. Certainly, a protective layer 423 also can be added on the blue fluorescence layer 422 for protecting the green fluorescence layer 421 and the blue fluorescence layer 422.

In the first embodiment of the present invention, a mixing light with a second color is formed by the following steps. Firstly, the red color light 42 provided by the LED device 401 is transmitted through the light guide plate, the reflection plate, the diffusion sheet, the prism sheet and so on and emitted uniformly from the surface of the back light module 40. Then, the red color light 42 passes through the surface protective layer 411 and the first protective layer 412 of the polarizer 41 and is transmitted into the green fluorescence layer 421 and the blue fluorescence layer 422, so as to excite the fluorescence powders thereof to generate the white color light 43. After that, the white color light 43 is transmitted through the protective layer 423 and into the polarizing layer 413 for being polarized. Finally, the polarized white color light 44 is transmitted through the second protective layer 414 and the adhesive layer 415 for the use of the panel display.

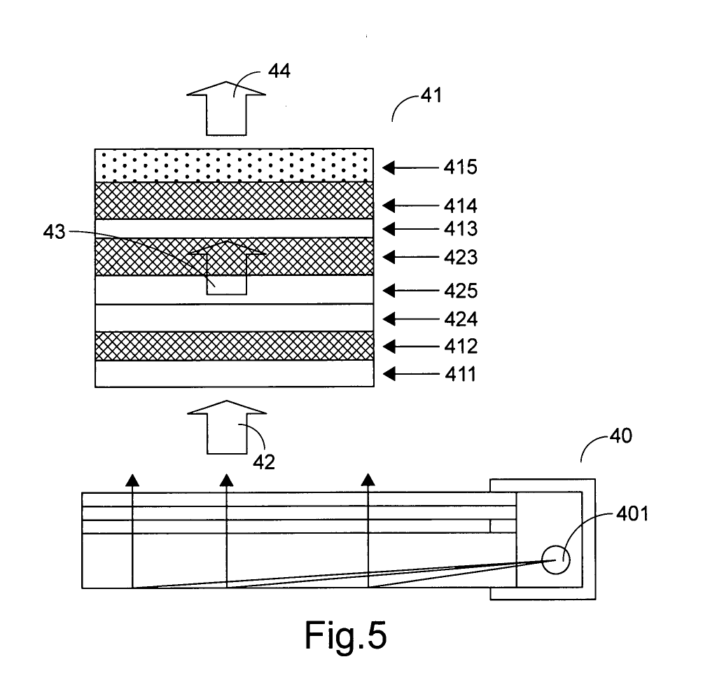

Please refer to FIG. 5, which illustrates a second preferred embodiment of a light structure for a panel display according to the present invention. As shown in FIG. 5, the back light module 40 introduces an LED 401 emitting green color light as the light source. Other than the surface protective layer 411, the first protective layer 412, the polarizing layer 413, the second protective 414 and the adhesive layer 415, the polarizer 41 also includes a red fluorescence layer 424 and a blue fluorescence layer 425 as light-mixing elements. Certainly, a protective layer 423 also can be added on the blue fluorescence layer 425 for protecting the red fluorescence layer 424 and the blue fluorescence layer 425.

In this embodiment of the present invention, a mixing light with a second color is formed by the following steps. Firstly, the green color light 42 provided by the LED device 401 is transmitted through the light guide plate, the reflection plate, the diffusion sheet, the prism sheet and so on and emitted uniformly from the surface of the back light module 40. Then, the green color light 42 passes through the surface protective layer 411 and the first protective layer 412 of the polarizer 41 and is transmitted into the red fluorescence layer 424 and the blue fluorescence layer 425, so as to excite the fluorescence powders thereof for generating the white color light 43 by means of light-mixing effect. After that, the white color light 43 is transmitted through the protective layer 423 and into the polarizing layer 413 for being polarized. Finally, the polarized white color light 44 is transmitted through the second protective layer 414 and the adhesive layer 415 for the use of the panel display.

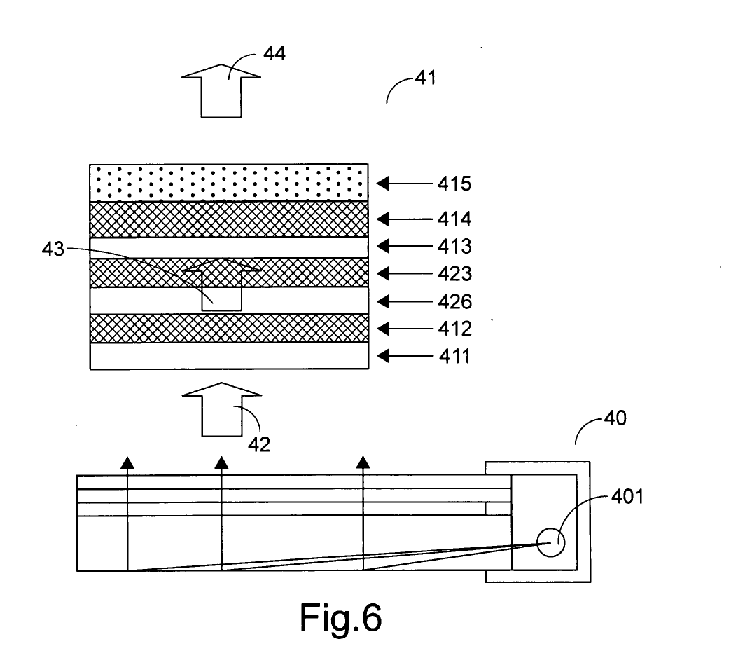

Please refer to FIG. 6, which illustrates a third preferred embodiment of a light structure for a panel display according to the present invention. As shown in FIG. 6, the back light module 40 introduces an LED 401 emitting blue color light as the light source. Other than the surface protective layer 411, the first protective layer 412, the polarizing layer 413, the second protective layer 414 and the adhesive layer 415, the polarizer 41 also includes a yellow fluorescence layer 426 as light-mixing element. Certainly, a protective layer 423 also can be added on the yellow fluorescence layer 426 for protecting the yellow fluorescence layer 426.

In this embodiment of the present invention, a mixing light with a second color is formed by the following steps. Firstly, the blue color light 42 provided by the LED device 401 is transmitted through the light guide plate, the reflection plate, the diffusion sheet, the prism sheet and so on and emitted uniformly from the surface of the back light module 40. Then, the blue color light 42 will pass through the surface protective layer 411 and the first protective layer 412 of the polarizer 41 and will be transmitted into the yellow fluorescence layer 426 so as to excite the fluorescence powders thereof for generating the white color light 43 by means of light-mixing effect. After that, the white color light 43 is transmitted through the protective layer 423 and into the polarizing layer 413 for being polarized. Finally, the polarized white color light 44 is transmitted through the second protective layer 414 and the adhesive layer 415 for the use of the panel display

In the above embodiments, the LED with red color, blue color and green color are described in terms of what are presently considered to be the most practical and preferred embodiments, it is to be understood that the invention needs not to be limited to the disclosed embodiments. A person well understanding the present invention can refer to the 1931 chromaticity diagram of International Commission on Illumination (CIE) and the emitting-light color of the LED to determine the color of the combined fluorescence layer or change the design of the polarizer, thereby generating a white color light or a mixing color light by means of light-mixing. Furthermore, the light structure of the present invention can be applied in all type panel displays, wherein a low temperature poly-silicon (LTPS) thin film transistor liquid crystal display (TFT-LCD) is the preferred choice. The polarizer 41 can also be the bottom polarizer of the panel display. Certainly, the invention can also apply in the top polarizer and the material substrates for other panel displays.

Accordingly, the invention introduces a polarizer for the panel display, wherein the polarizer includes at least one fluorescence layer to be excited by the emitting light of a non-white LED for generating a white light or a mixing light in a second color for the panel display. The present invention merely introduces a non-white LED to generate a white light for the panel display and then the lifetime of the panel display will increase and the manufacturing cost will decrease. Thus, the present invention is practicable for the industry and can be applied accordingly.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A light structure of a panel display comprising:
a back light module having a light source for generating a first color light; and
a polarizer having at least one fluorescence layer to be excited by said first color light so as to generate a white light or a mixing light in a second color.

2. The light structure according to claim 1, wherein said polarizer is a top polarizer or a bottom polarizer of said panel display.

3. The light structure according to claim 2, wherein said fluorescence layer is disposed between a polarizing layer and a surface protective layer both of said top polarizer or both of said bottom polarizer.

4. The light structure according to claim 1, wherein said polarizer further comprises at least one protective layer for protecting said fluorescence layer.

5. The light structure according to claim 1, wherein said light source is a light emitting diode (LED).

6. The light structure according to claim 5, wherein said first color light is in red.

7. The light structure according to claim 6, wherein said polarizer further comprises a green fluorescence layer and a blue fluorescence layer, said fluorescence layers being excited by said first color light so as to generate said white light or said mixing light in a second color.

8. The light structure according to claim 5, wherein said first color light is in green.

9. The light structure according to claim 8, wherein said polarizer further comprises a red fluorescence layer and a blue fluorescence layer, said fluorescence layers being excited by said first color light so as to generate said white light or said mixing light in a second color.

10. The light structure according to claim 5, wherein said first color light is in blue.

11. The light structure according to claim 10, wherein said polarizer further comprises a yellow fluorescence layer excited by said first color light so as to generate said white light or said mixing light in a second color.

12. The light structure according to claim 1, wherein said panel display is a low temperature poly-silicon (LTPS) thin film transistor liquid crystal display (TFT-LCD).

13. A polarizer disposed on a back light module of a panel display and characterized in that:
said polarizer comprises at least one fluorescence layer to be excited by a first color light so as to generate a white light or a mixing light in a second color.

14. The polarizer according to claim 13, wherein said first color light is in red.

15. The polarizer according to claim 14, wherein said polarizer further comprises a green fluorescence layer and a blue fluorescence layer, said fluorescence layers being excited by said first color light so as to generate said white light or said mixing light in a second color.

16. The polarizer according to claim 13, wherein said first color light is in green.

17. The polarizer according to claim 16, wherein said polarizer further comprises a red fluorescence layer and a blue fluorescence layer, said fluorescence layers being excited by said first color light so as to generate said white light or said mixing light in a second color.

18. The polarizer according to claim 13, wherein said first color light is in blue.

19. The polarizer according to claim 18, wherein said polarizer further comprises a yellow fluorescence layer excited by said first color light so as to generate said white light or said mixing light in a second color.

20. The polarizer according to claim 13, wherein said polarizer further comprises an adhesive layer, a plurality of protective layers, a polarizing layer and a surface protective layer.
